(19) United States
(12) Patent Application Publication
(10) Pub. No.: US 2012/0048915 A1
(43) Pub. Date: Mar. 1, 2012

(54) EMERGENCY MEDICAL INFO PAK

(76) Inventor: Harlyene Goss, Lawrence, MA (US)

(21) Appl. No.: 13/195,222

(22) Filed: Aug. 1, 2011

Related U.S. Application Data
(60) Provisional application No. 61/373,059, filed on Aug. 12, 2010.
(60) Provisional application No. 61/373,047, filed on Aug. 12, 2010.

(51) Int. Cl. B65D 27/12; G09F 3/00

(52) U.S. Cl. 229/76; 40/299.01

(57) ABSTRACT

The present invention generally relates to emergency medical information containers. Specifically, this invention relates to an emergency medical information package that is configured to organize, separate and protect relevant personal and medical information related to an individual in case of an emergency.

### CROSS REFERENCE TO RELATED APPLICATIONS

This application claims the benefit of U.S. Provisional Patent Application No. 61/373,059 filed Aug. 12, 2010, the entire disclosure of which is incorporated herein by reference. The application also claims the benefit of U.S. Provisional Patent Application No. 61/373,047, filed Aug. 12, 2010, the entire disclosure of which is incorporated herein by reference.

### FIELD OF THE INVENTION

The present invention generally relates to emergency medical information containers. Specifically, this invention relates to an emergency medical information package that is configured to organize, separate and protect relevant personal and medical information related to an individual in case of an emergency.

### BACKGROUND OF THE INVENTION

Currently, if an individual becomes hurt or ill, the immediate response it for that individual or other individuals in the vicinity to contact emergency personnel to respond and aid the injured individual. Typically, this involves calling “911” and requesting the appropriate assistance (e.g., ambulance, police). Once contacted, the emergency personnel are dispatched to the scene.

Upon arrival at the scene, it is commonplace for emergency personnel to ask several questions of the injured individual or other individuals in the area. Depending on the injuries sustained by the injured individual and the relationship of the other individuals in the vicinity to the injured individual, it is often difficult or impossible for the emergency personnel to get the necessary answers to these questions.

The inability to get answers to questions related to the injured individual can result in unnecessary further damage to the patient. This can include the provision of medicines to an injured individual that the injured individual may be allergic to or that complicate other underlying health issues (e.g., high blood pressure). Each year, there are a significant amount of deaths or compounded injuries due to the inability of emergency personnel to get detailed information related to injured individuals prior to enacting emergency medical treatment.

Therefore, there is a need in the art for a system, method and apparatus for providing emergency personnel with easy access to an individual's pertinent medical information. These and other features and advantages of the present invention will be explained and will become obvious to one skilled in the art through the summary of the invention that follows.

### SUMMARY OF THE INVENTION

Accordingly, it is an object of the present invention to provide an emergency medical information package comprised of a reusable, reclosable container that is capable of retaining an individual's complete medical history or any portion thereof.

According to an embodiment of the present invention, the reclosable container portion of an emergency medical information package is comprised of a reclosable main container cavity and a secondary front container cavity.

According to an embodiment of the present invention, said reclosable main cavity is configured to receive documents related to the treatment, care and personal preferences of an individual (e.g., living will, complete medical history).

According to an embodiment of the present invention, said secondary cavity is configured to receive emergency medical information related to an individual.

According to an embodiment of the present invention, an exterior wall of said secondary front cavity is comprised of an opaque material, such that materials contained within said secondary cavity are visible but obscured from the exterior.

According to an embodiment of the present invention, an emergency medical information package is comprised of one or more magnetic components attached to a rear wall of said emergency medical information package.

According to an embodiment of the present invention, an emergency medical information package may be further comprised of an electronic medical record device retention component.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 shows a front view of an emergency medical information package in accordance with an embodiment of the present invention;

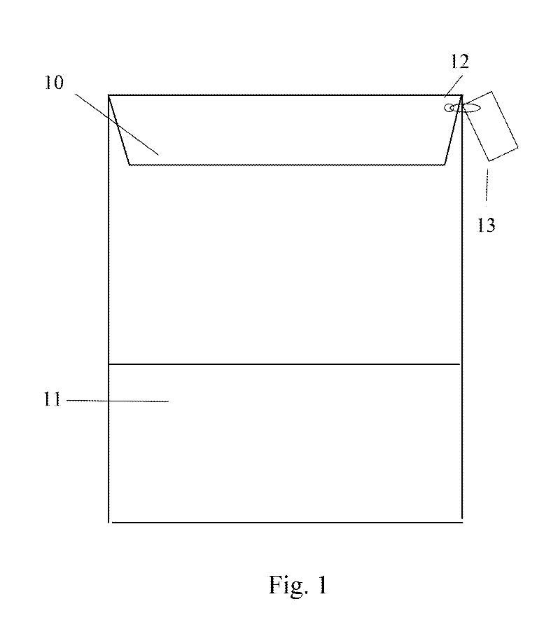

FIG. 2 shows a front view of an emergency medical information package in accordance with an embodiment of the present invention;

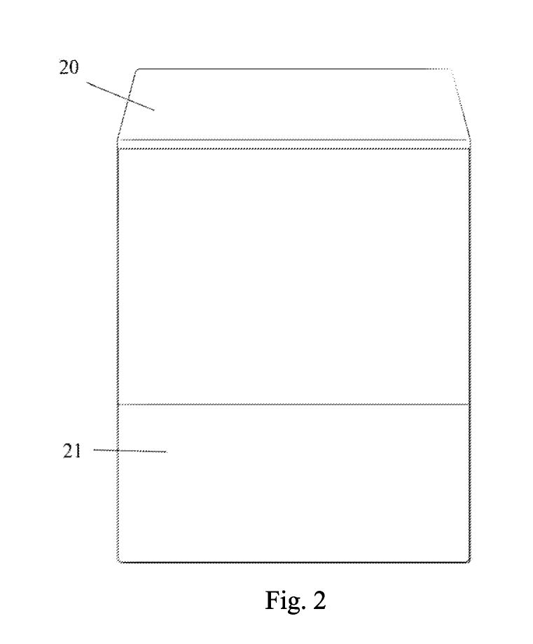

FIG. 3 shows a front view of an emergency medical information package in accordance with an embodiment of the present invention;

FIG. 4 shows a rear view of an emergency medical information package in accordance with an embodiment of the present invention;

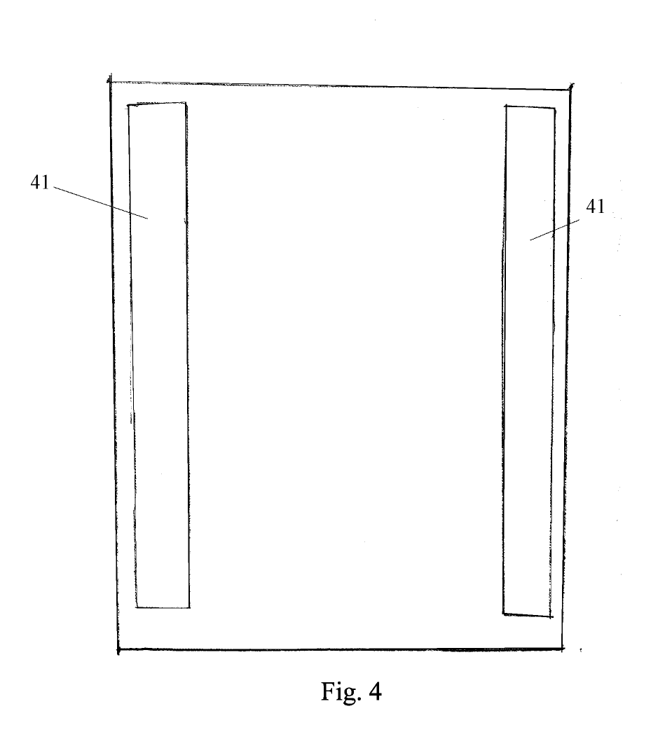

FIG. 5 shows a front view of an emergency medical information summary form in accordance with an embodiment of the present invention;

FIG. 6 shows a rear view of an emergency medical information summary form in accordance with an embodiment of the present invention;

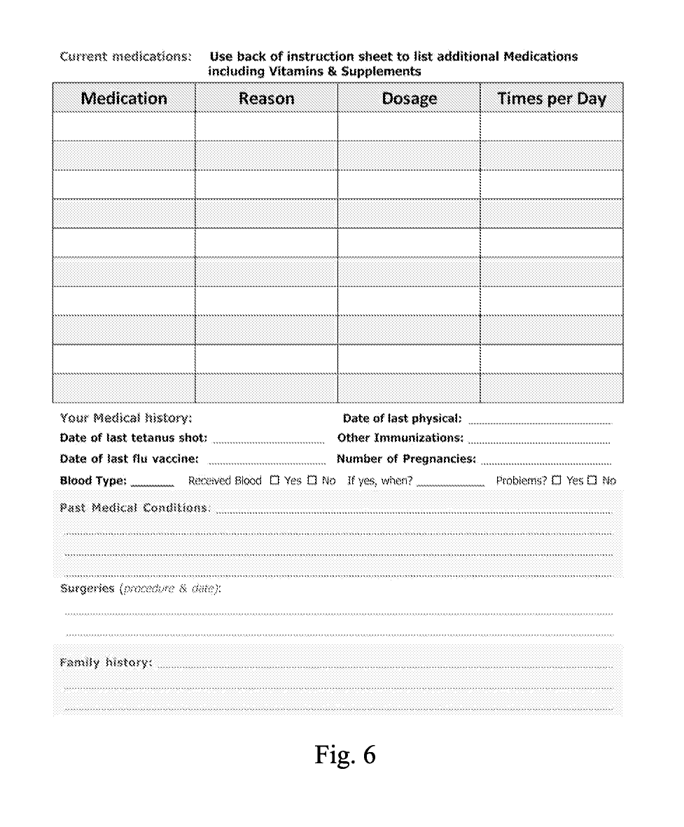

FIG. 7 shows a front view of a health care proxy form in accordance with an embodiment of the present invention;

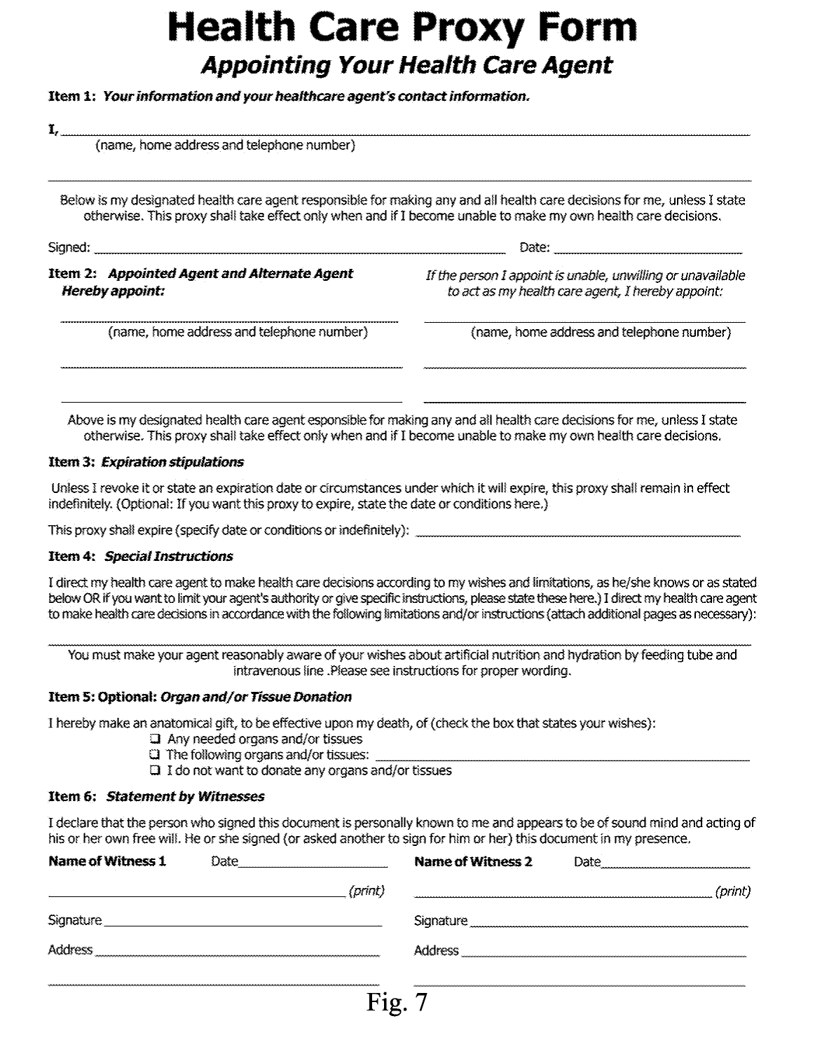

FIG. 8 shows a rear view of a health care proxy form in accordance with an embodiment of the present invention; and

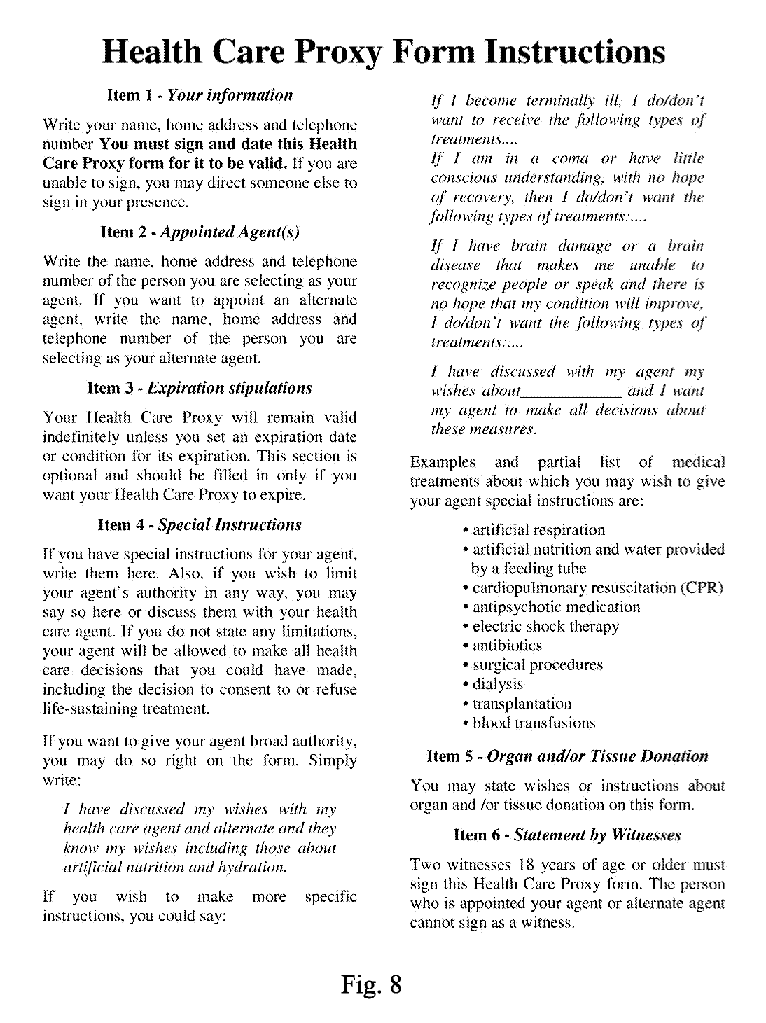

FIG. 9 shows a front and rear view of an emergency medical information wallet card in accordance with an embodiment of the present invention.

### DETAILED SPECIFICATION

The present invention generally relates to emergency medical information containers. Specifically, this invention relates to an emergency medical information package that is configured to organize, separate and protect relevant personal and medical information related to an individual in case of an emergency.

Turning now to, According to an embodiment of the present invention, an emergency medical information package is comprised of a reclosable bag. The reclosable bag is further comprised of an envelope like structure that is substantially flat and has a reclosable main cavity 10, formed from a joined front wall and rear wall of the reclosable bag. The reclosable main cavity of the reclosable bag may be opened and closed by way of a closing element (described in detail below).

The reclosable main cavity 10 is designed to receive a complete medical history related to an individual and one or more documents related to the personal preferences of the individual (e.g., living will, complete medical history). The complete medical history may include, but is not limited to, medical records, allergy notifications, medication notifications, insurance cards, healthcare proxies, living wills and test results. One of ordinary skill in the art would appreciate that there are numerous forms of records that could be included in a complete medical history and retained in said reclosable main cavity 10 of emergency medical information packages in accordance with embodiments of the present invention, and embodiments of the present invention are contemplated for use with any type of records associated with a complete medical history.

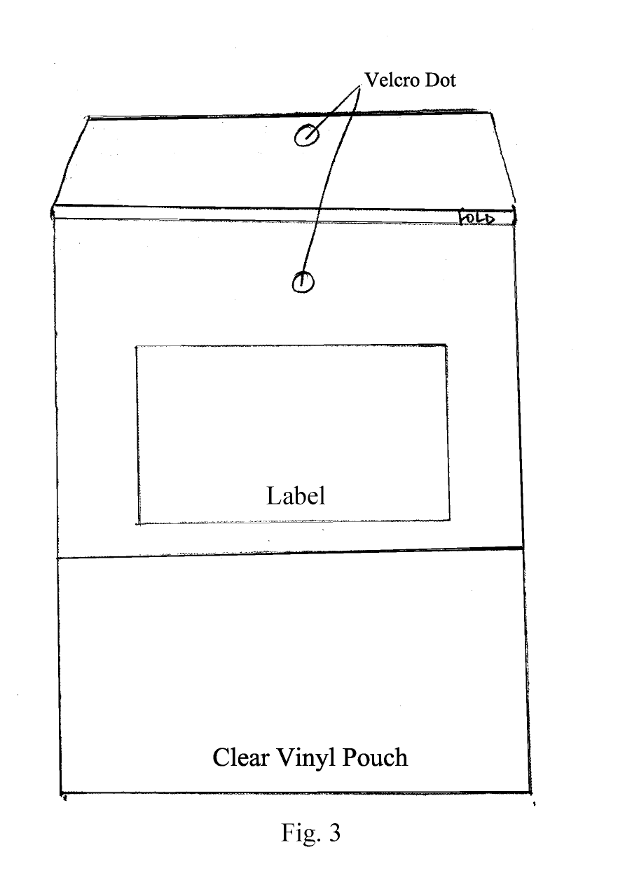

According to an embodiment of the present invention, a closing element 20 is located at one end of the reclosable main cavity 10 and is attached to the envelope like structure in one or more locations. The closing element 20 is configured to allow for the sealing of the reclosable main cavity 10 in order to protect the contents within. Closing elements 20 may include, but are not limited to, zip-lock style closures, zipper closures, hook & loop fasteners, Velcro fasteners (FIG. 3) and string and post closures. One of ordinary skill in the art would appreciate that numerous types of closing elements 20 may be used with embodiments of the present invention, and embodiments of the present invention are contemplated for use with any type of closing element 20.

According to an embodiment of the present invention, the rear wall of the envelope like structure may be further comprised of one or more magnetic components 41 configured to secure the reclosable bag against a ferromagnetic material or another material capable of attracting or being attracted to a magnet. In this manner, the emergency medical information package may be stored conveniently in a location that would be readily apparent and easily located by emergency personnel. In an exemplary embodiment, the magnetic components 41 may be removable from the emergency medical information package. Advantageously, removable magnetic components 41 allow for the emergency medical information package to be transported with the individual where the additional weight of the magnetic components 41 or the magnetic properties of the magnetic components 41 would be undesirable.

According to an embodiment of the present invention, the front wall of the envelope like structure may be further comprised of a secondary front cavity 11 formed by a secondary enclosure attached to the front wall of the envelope. The secondary front cavity 11 is configured to receive emergency medical information that would be most important to first responding emergency personnel. Emergency medical information includes, but is not limited to, food/drug allergies, existing medical conditions, whether an individual is an organ donor and whether the individual should be taken to a particular medical center due to special needs. One of ordinary skill in the art would appreciate that there are numerous types of emergency medical information that could be stored in the secondary front cavity 11 in accordance with embodiments of the present invention, and embodiments of the present invention are contemplated for use with the storage of any type of emergency medical information.

According to an embodiment of the present invention, the secondary front cavity 11 may be further comprised of a secondary front cavity closing element configured to allow for the sealing of the secondary front cavity 11 in order to protect the contents within. Secondary front cavity closing elements may include, but are not limited to, zip-lock style closures, zipper closures, Velcro fasteners and string and post closures. One of ordinary skill in the art would appreciate that numerous types of secondary front cavity closing elements may be used with embodiments of the present invention, and embodiments of the present invention are contemplated for use with any type of secondary front cavity closing element.

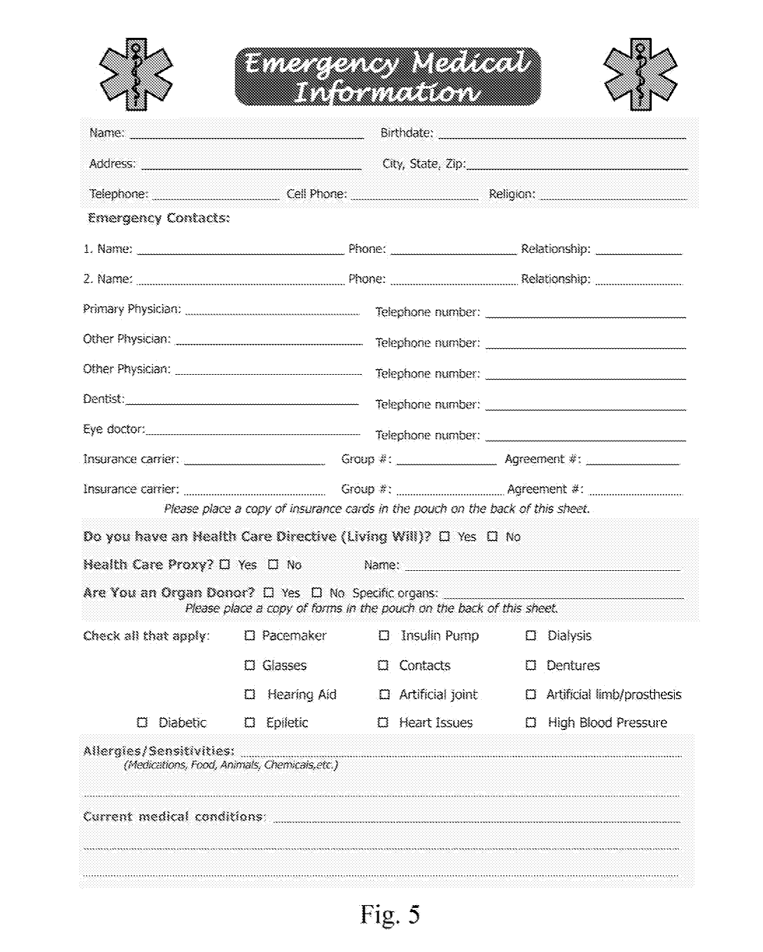

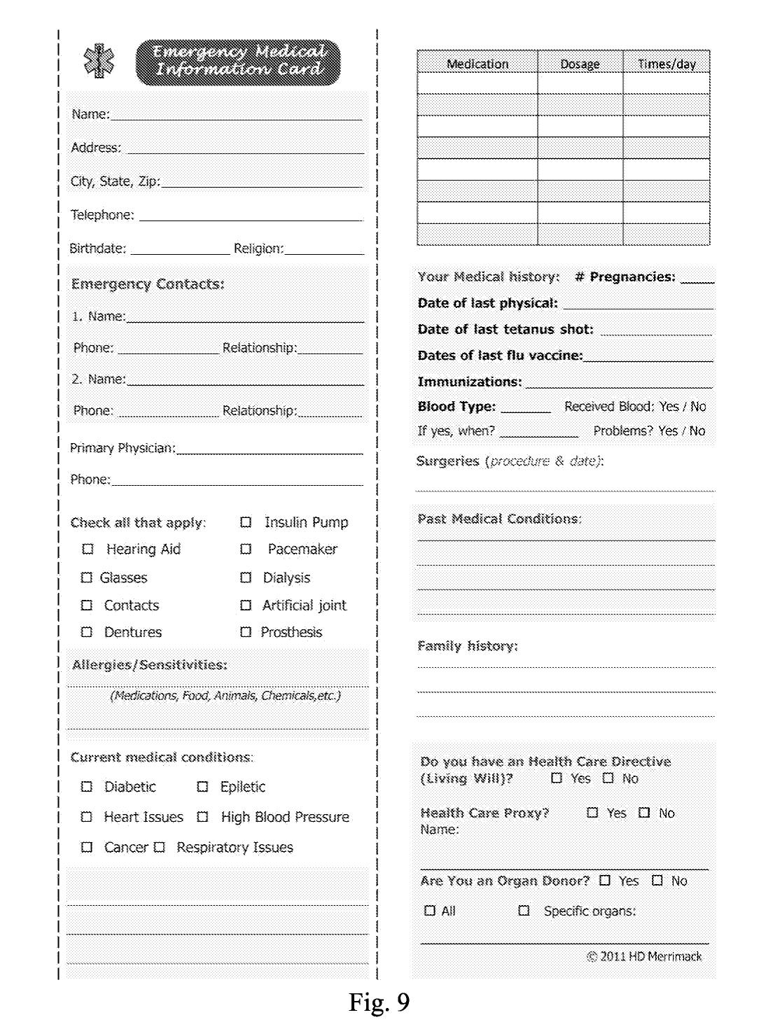

According to an embodiment of the present invention, the secondary enclosure may be constructed from an opaque material (e.g., vinyl, plastic) to allow emergency personnel the ability to see that the contents of the secondary front cavity 11, but potentially not be able to read the contents without close inspection. This allows for the contents of the secondary front cavity 11 to be obscured in order to protect the individual's personal medical information (i.e., in accordance with HIPAA privacy standards). In an exemplary embodiment, the contents can be highlighted by the inclusion of a bright and colorful emergency medical information card, such as the exemplary embodiments of emergency medical information wallet cards and summary forms shown in FIG. 5 and FIG. 9 (note, color not shown in the attached figures). In an alternate embodiment, the secondary enclosure could be constructed from a transparent material. In yet another alternate embodiment, the secondary enclosure could be constructed from a non-transparent material. One of ordinary skill in the art would appreciate that the secondary front enclosure could be constructed from numerous materials in accordance with embodiments of the present invention, and embodiments of the present invention are contemplated for use with any type of secondary front enclosure construction material.

According to an embodiment of the present invention, the emergency medical information package may be made in highly colorful or other manner in order to draw attention to itself. In this manner, emergency personnel will be directed to the emergency medical information package by its loud and outstanding characteristics. This may include the use of familiar marks, such as symbols utilized by various emergency medical centers or personnel. Optionally, the emergency medical information package may be standardized in appearance such that emergency personnel would recognize the appearance of the emergency medical information package as such when responding to an emergency.

According to an embodiment of the present invention, by providing a secondary front cavity 11 for the retention of emergency medical information which is separate from a reclosable main cavity 10 which is configured to retain a complete set of medical and personal records, emergency personnel will be able to retrieve the important emergency medical information without being required to sort through nonessential material. Advantageously, the amount of time required to assess and properly treat an injured individual may be dramatically reduced and also reduces the chance that an injured individual would receive treatment that may complicate his/her injuries (e.g., the application of drugs to which the injured individual is allergic).

According to an embodiment of the present invention, the emergency medical information package may be further comprised of an optional printed label. Ideally, the printed label may be affixed to the front of the emergency medical information package, directly above the secondary front cavity. The printed label would contain information related to identification of an individual.

According to an embodiment of the present invention, the emergency medical information package may be further comprised of an electronic medical information storage device retention means 12. Electronic medical information storage device retention means 12 include key rings, key chains, clip-on attachments and adhesives. One of ordinary skill in the art would appreciate that there are numerous types of electronic medical information storage device retention means 12 that could be used with embodiments of the present invention, and embodiments of the present invention are contemplated for use with any type of electronic medical information storage device retention means 12.

Electronic medical information storage devices 13 include, but are not limited to, USB memory sticks, flash memory cards or other portable computer-readable storage mediums. One of ordinary skill in the art would appreciate that there are numerous types of electronic medical information storage devices 13 that could be used with embodiments of the present invention, and embodiments of the present invention are contemplated for use with any type of electronic medical information storage device 13.

Exemplary Embodiment

The following is an exemplary embodiment of the present invention. In accordance with the exemplary embodiment, the emergency medical information package may be comprised of a 8″×10″ slider reclosable bag (reclosable main cavity 10), a 4″×10″ slider secondary front cavity (secondary front cavity 11), one or more ¾″ wide by 7.5″ long magnetic strips (magnetic component 41), a printed label and a medical information wallet card and/or summary form (e.g., FIG. 5, FIG. 9). In this embodiment, the medical information form would be configured to fit inside the slider secondary front cavity and would contain all relevant emergency medical information related to an individual.

In another exemplary embodiment of the present invention, the emergency medical information package may be further comprised of an eye-and-loop (electronic medical information storage device retention means 12) for holding a USB device containing the individual's medical information (electronic medical information storage device 13).

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An emergency medical information package comprising:
an envelope-like structure comprised of a front wall, a rear wall,
wherein said front wall and rear wall are joined to form an main cavity with a main opening on one end;
a main closing means, attached to said one end of said envelope like structure with said main opening,
wherein said main closing means is configured to allow for the opening and closing of said main opening;
a secondary enclosure attached to said front wall in such a manner as to create a secondary cavity and a secondary cavity opening at one end of said secondary cavity;
a secondary closing means attached to said one end of said secondary cavity with said secondary cavity opening,
wherein said secondary closing means is configured to allow for the opening and closing of said secondary cavity opening; and
one or more magnetic components attached to said rear wall.

2. The emergency medical information package of claim 1, wherein said main cavity is configured to receive supporting documentation and information.

3. The emergency medical information package of claim 1, wherein said secondary cavity is configured to receive a set of emergency medical information.

4. The emergency medical information package of claim 1, wherein said one or more magnetic components are configured to allow for said emergency medical information package to be attached to a ferromagnetic material.

5. The emergency medical information package of claim 1, wherein said front wall is further comprised of a printed label.

6. The emergency medical information package of claim 5, wherein said printed label is comprised of identification information.

7. The emergency medical information package of claim 1, envelope-like structure is further comprised of an electronic medical information storage device retention means.

8. The emergency medical information package of claim 7, wherein said electronic medical information storage device retention means is configured to retain one or more electronic medical information storage devices.
